(19) United States
(12) Patent Application Publication
(10) Pub. No.: US 2023/0039174 A1
(43) Pub. Date: Feb. 9, 2023

(54) Control Of Cleanup Engine In A Biomass Conversion System

(71) Applicant: Massachusetts Institute of Technology, Cambridge, MA (US)

(72) Inventors: Leslie Bromberg, Sharon, MA (US); Emmanouil Kasseris, Cambridge, MA (US); Yu Chen, Allston, MA (US)

(21) Appl. No.: 17/792,827

(22) PCT Filed: Aug. 13, 2020
(86) PCT No.: PCT/US2020/046117

§ 371 Date: Jul. 14, 2022

Related U.S. Application Data
(60) Provisional application No. 62/965,197, filed on Jan. 24, 2020.

(51) Int. Cl. C10K 1/02; C10K 1/00; G05B 15/02

(52) U.S. Cl. CPC C10K 1/024; C10K 1/002; G05B 15/02

(57) ABSTRACT

A biomass conversion system is disclosed. The system comprises a syngas generator, a cleanup engine and a power producing engine. The power producing engine is coupled to a load, such as an electrical generator. Modifications to the cleanup engine to enhance performance are described. Additionally, methods of controlling the cleanup engine in response to changes in load are disclosed. In certain embodiments, the air-to-fuel ratio, and/or recirculation gases are varied. In other embodiments, a chemical synthesis reactor may be coupled to the output of the cleanup engine.

This application claims priority to U.S. Provisional Patent Application Ser. No. 62/965,197, filed Jan. 24, 2020, the disclosure of which is incorporated by reference in its entirety.

### FIELD

The present invention is in the technical field of power generation; and more specifically, in the technical field of purification control and power generation resulting from the gasification of solid fuel.

### BACKGROUND

There is a clear and unmet need for transformative technologies to improve biomass to power systems by reducing their cost and complexity to make them more competitive with fossil fuels.

According to the Union of Concerned Scientists, biomass resources totaling just under 680 million dry tons could be made available, in a sustainable manner, each year within the United States by 2030. This is enough biomass to produce 732 billion kilowatt-hours of electricity (19 percent of total U.S. power consumption in 2010). These biomass resources are distributed widely across the United States, ensuring that communities across America can benefit both financially and environmentally from increased biomass production. If allowed to biodegrade on its own, this biomass will generate substantial amounts of greenhouse gas (GHG) methane emissions. Approximately 6.5 liters of CH₄ are generated per kilogram of decaying biomass.

Globally, biomass represents a huge hope for rural electrification in a sustainable, low cost manner that can trigger economic development based on largely local resources. According to the World Bank, rural electrification can have a profound impact on reducing poverty and improving welfare in the developing world. The developing world already relies on biomass for its energy needs, in particular, for cooking. Furthermore, developing decentralized power generation in the developing world may in many cases make more sense compared to having to invest in a large centralized grid.

Because of the cost of transporting the biomass, biomass is preferably consumed locally, using small gasifiers. The main limitation of small scale gasification systems today is the cost of gas cleanup.

The producer gas created from biomass gasification has high tar content. Tars are large molecule hydrocarbons and are considered contaminants because they cause fouling on hardware surfaces, such as pipes, catalysts and valves. The tar content in the producer gas needs to be reduced to a certain level before further utilization of the syngas, such as for power generation or chemical synthesis. Although there are many existing, mature tar purification technologies, these technologies are usually expensive, which makes the commercial utilization of syngas with high tar content becomes unfeasible.

The idea of using hot, rich combustion in an internal combustion engine as a cleanup system to break down tar into small molecule hydrocarbons was proposed in WO2018119032A1 as a replacement of existing tar purification technologies. The purpose of hot combustion (above the tar dew point) is to break down the tars while they are still in the gaseous phase, before they can condense to cause fouling. The purpose of rich combustion is to release enough heat to break down tars into smaller molecules that do not cause fouling, but not damage the engine due to autoignition, while maintaining sufficient heating value of the exhaust gas for combustion downstream of the cleanup engine. The gases inside the engine are prone to autoignition due zo the high intake temperatures. Limiting the stoichiometry to rich controls the amount of autoignition heat release and thus protects the engine.

The successful application of the engine cleanup system may bring down the tar purification cost of syngas significantly. The purified syngas then can be directly used in a power producing engine or to manufacture chemicals. Consequently, the commercial utilization of biomass gasification becomes feasible.

The integrated system proposed in WO2018119032A1 has three separate components that must be independently controlled and powered. Therefore, a system and method that allows for the control of these components would be beneficial.

### SUMMARY

A biomass conversion system is disclosed. The system comprises a syngas generator, a cleanup engine and a power producing engine. The power producing engine is coupled to a load, such as an electrical generator. Modifications to the cleanup engine to enhance performance are described. Additionally, methods of controlling the cleanup engine in response to changes in load are disclosed. In certain embodiments, the air-to-fuel ratio, and/or recirculation gases are varied. In other embodiments, a chemical synthesis reactor may be coupled to the output of the cleanup engine.

According to one embodiment, integrated system for producing power from solid fuels is disclosed. The system comprises a syngas generator to form producer gas from solid fuels; a cleanup engine in communication with an outlet of the syngas generator to remove tar from the producer gas and create cleaned syngas; a power producing engine in communication with an outlet of the cleanup engine to generate power; a power engine fuel actuator disposed between the outlet from the cleanup engine and an inlet of the power producing engine; a cleanup air filter; a cleanup air actuator in communication with the cleanup air filter and an inlet of the cleanup engine; a cleanup engine sensor; a cleanup exhaust temperature sensor; and a controller in communication with the cleanup engine sensor, the cleanup exhaust temperature sensor and the cleanup air actuator. In certain embodiments, a distance between the outlet of the syngas generator and an input to the cleanup engine is less than 36 inches. In some embodiments, a manifold between the outlet of the syngas generator and an input to the cleanup engine is thermally insulated. In certain embodiments, each cylinder of the cleanup engine has exactly one intake valve. In certain embodiments, an intake runner and port are used to deliver producer gas to a cylinder of the cleanup engine and the intake runner and port have straight designs with uniform inner diameters. In certain embodiments, an engine cylinder head of the cleanup engine comprises a pent roof. In some embodiments, a valve spring used to control an intake valve has a spring constant that is 20-80% greater than conventional valve springs. In certain embodiments, the air is heated prior to entering the inlet of the cleanup engine.

According to another embodiment, an integrated system for producing power from solid fuels is disclosed. The system comprises a syngas generator to form producer gas from solid fuels; a cleanup engine in communication with an outlet of the syngas generator to remove tar from the producer gas and create cleaned syngas; a power producing engine in communication with an outlet of the cleanup engine to generate power; a power engine fuel actuator disposed between the outlet from the cleanup engine and an inlet of the power producing engine; a cleanup air filter; a cleanup air actuator in communication with the cleanup air filter and an inlet of the cleanup engine; a cleanup engine sensor; a cleanup exhaust temperature sensor; an electrical generator coupled to a drive shaft of the power producing engine; and a controller in communication with the cleanup engine sensor, the cleanup exhaust temperature sensor and the cleanup air actuator. In certain embodiments, the controller monitors the cleanup exhaust temperature sensor and adjusts the cleanup air actuator in response to values received from the cleanup exhaust temperature sensor. In some embodiments, the controller maintains an air-to-fuel ratio (λ) of the cleanup engine within a predetermined range. In certain embodiments, the cleanup engine sensor comprises a knock sensor, and an upper and lower limit of λ is determined based on an output of the cleanup engine sensor and/or exhaust temperature from the cleanup exhaust temperature sensor. In certain embodiments, the knock sensor is an accelerometer, an acoustic device or both. In certain embodiments, the system further comprises a syngas fuel actuator; and a syngas air actuator; wherein a load presented by the electrical generator varies over time and the controller varies a flow rate of solid fuel and/or air entering the syngas generator in response to variation in the load. In some embodiments, an output gas from the power producing engine is recirculated back to an input to the cleanup engine and wherein a load presented by the electrical generator varies over time and the controller controls the cleanup air actuator to maintain an air-to-fuel ratio (λ) within a predetermined range. In certain embodiments, an operating speed of the cleanup engine is between 600 and 1500 RPM. In some embodiments, a compression ratio of the cleanup engine is between 11:1 and 22:1. In some embodiments, a relative air-to-fuel ratio of the cleanup engine is between 0.1 and 0.5.

According to another embodiment, an integrated system for synthesizing chemicals from solid fuels is disclosed. The system comprises a syngas generator to form producer gas from solid fuels; a cleanup engine in communication with an outlet of the syngas generator to remove tar from the producer gas and create cleaned syngas; and an engine reactor in communication with an outlet of the cleanup engine to synthesize the cleaned syngas into a desired chemical. In some embodiments, exhaust from the cleanup engine is pressurized before entering the engine reactor. In certain embodiments, the cleanup engine and the engine reactor share a common drive shaft and a displacement of the cleanup engine is greater than the displacement of the engine reactor. In some embodiments, the cleanup engine is operated at a higher RPM than the engine reactor.

### BRIEF DESCRIPTION OF THE DRAWINGS

For a better understanding of the present disclosure, reference is made to the accompanying drawings, in which like elements are referenced with like numerals, and in which:

FIG. 1A is a first embodiment of an integrated power system;

FIG. 1B is a second embodiment of an integrated power system;

FIG. 2 is a chart showing the relationship between the output of a knock sensor and the maximum rate of pressure rise (MRPR);

FIG. 3 is a chart showing the relationship between air-to-fuel ratio (λ) and MRPR;

FIG. 4 is a chart showing the relationship between air-to-fuel ratio (λ) and exhaust temperature;

FIG. 5 is a chart showing the relationship between cyclic dispersion (the standard deviation of indicated mean effective pressure, σᵢₘₚ) and accelerometric index (calculated from the accelerometer signal);

FIG. 6A-6B show two designs of the intake runner and port for the cleanup engine;

FIG. 7 shows a chart showing the relationship between air-to-fuel ratio and cyclic dispersion;

FIG. 8 shows a configuration of the generator flare and intake for the cleanup engine according to one embodiment; and

FIG. 9 shows another embodiment of an integrated system using a cleanup engine.

### DETAILED DESCRIPTION

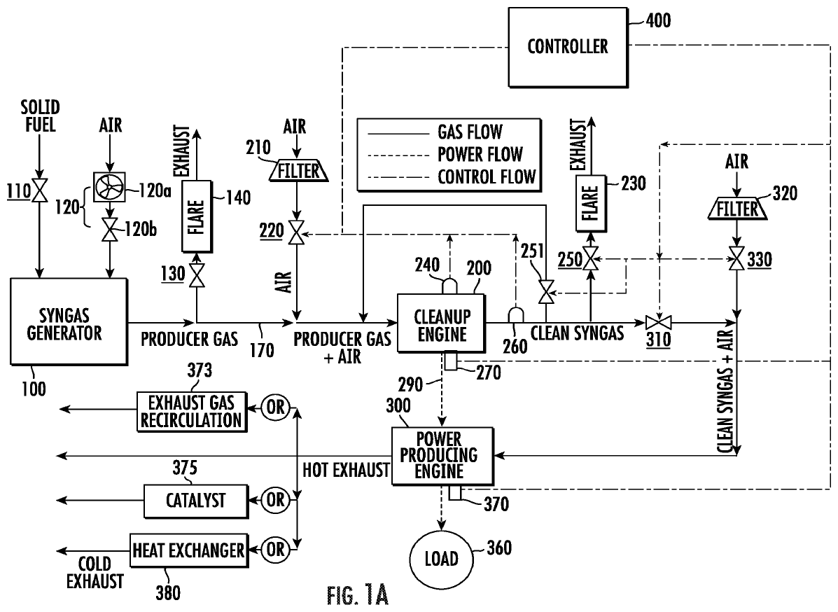

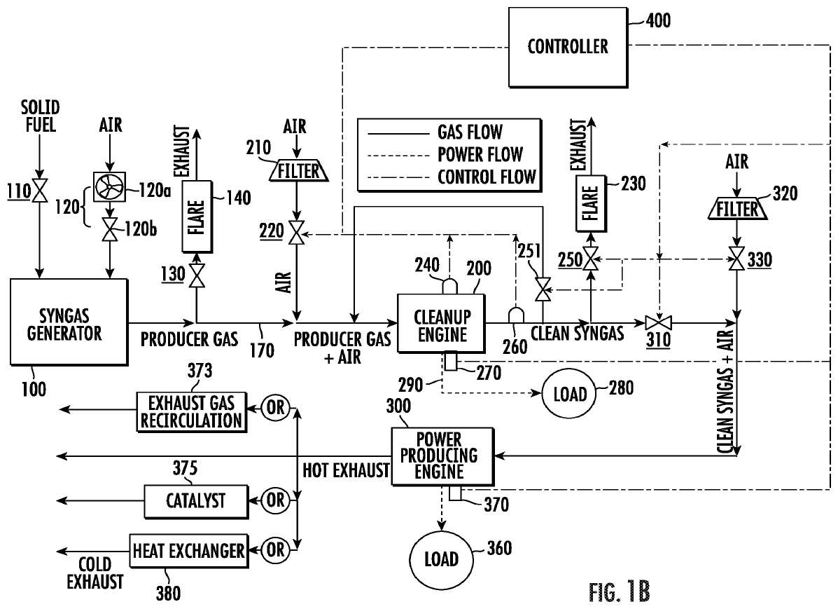

FIGS. 1A-1B show an integrated system for converting solid fuel to gas, removing heavy organic contaminants (‘tars’) from the gas and generating power for any use according to two embodiments. The integrated system comprises a syngas generator 100, a cleanup engine 200 and a power producing engine 300.

Each of the components will be described in more detail. The goal of the integrated system is to maintain the tar-laden producer gas temperature above the dew point of organic contaminants. That dew point is around 250-350° C. Therefore, if gas is never cooled below the tar dew point or the dew point of the heaviest tars and is combusted, there would be no need for expensive and complicated tar clean up equipment as the tar would simply get burned.

The syngas generator 100 may be a gasifier. Further, the syngas generator 100 may comprise other components, such as a high temperature filter or cyclone, to remove solid contaminants. Additionally, a heat exchanger may be part of the syngas generator 100. The structure of the syngas generator 100 is not limited by this disclosure.

In operation, biomass or other organic material is fed to a syngas generator 100. The syngas generator 100 generates a gas, which is a mixture of CH₄, CO, H₂, H₂O, N₂ and heavier organic components, referred to as ‘tars’. Because the output of the syngas generator 100 contains components which are not typically considered to be syngas, the output of the syngas generator 100 is referred to as producer gas in this disclosure. This producer gas exits the syngas generator 100 at temperatures that can be in excess of 700 degrees centigrade.

The syngas generator 100 has two inputs, the solid fuel, which may be biomass, and an oxidant, such as air, pure oxygen and/or steam. In certain embodiments, a syngas fuel actuator 110 may be disposed prior to the input to the syngas generator 100 to regulate or stop the flow of solid fuel into the syngas generator 100. This syngas fuel actuator 110 may be a conveyor, such as a screw conveyor, a worm conveyor or a hopper. Additionally, a syngas air actuator 120 may be disposed prior to the input to the syngas generator 100 to control the flow of air or another oxidant into the syngas generator 100. In certain embodiments, the syngas air actuator 120 may comprise two components. For example, the syngas air actuator 120 may include a fan or blower 120a and a syngas air valve 120b. Thus, the syngas air actuator 120 may have three different states:
disabled or closed, where the syngas air valve 120b is closed such that air cannot pass through the syngas air actuator 120;
enabled or open, where the syngas air valve 120b is open but the fan or blower 120a is disabled; and
active, where the syngas air valve 120b is open and the fan or blower 120a is actuated.

In other words, when the syngas air actuator 120 is enabled, air is not forced into the syngas generator 100. However, the syngas generator 100 may still be able to draw air into the generator. Thus, enabling the syngas air actuator 120 without activating the fan or blower 120a does not stop the flow of air; it merely stops the flow of forced air. In other words, in induction mode, the engine sucks air through the syngas generator 100 without needing to actuate the fan or blower 120a in the syngas air actuator 120, especially when the syngas flare actuator 130 is closed.

In certain embodiments, the air upstream of the syngas generator 100 may be compressed prior to introduction into the syngas generator 100. The air may be compressed using a suitable compressor, such as a turbocharger or a supercharger.

The outlet of the syngas generator 100 is in communication with the inlet to the cleanup engine 200. The outlet of the syngas generator 100 may be a manifold, pipe or other enclosed structure through which the producer gas may flow. Additionally, the outlet of the syngas generator 100 is in communication with a syngas flare actuator 130. The syngas flare actuator 130 may a valve that enables or blocks the flow of producer gas to the generator flare 140. The generator flare 140 is used to burn any producer gas that flows into the generator flare 14C. In certain embodiments, the generator flare 140 may comprise an automated spark plug, sensors for emissions and means for emission control. In other embodiments, the generator flare 140 may be a length of pipe with an expansion to hold the flame that is manually lit. The generator flare 140 is used to ensure that producer gas, which contains poisonous carbon monoxide and explosive hydrogen gas, is not vented into the atmosphere. The generator flare 140 and the syngas flare actuator 130 may be connected via a manifold, pipe, tube or other suitable structure.

The outlet of the syngas generator 100 may also be in communication with a cleanup air actuator 220. The cleanup air actuator 220 may be a valve that controls the flow of air or another oxidant into the inlet of the cleanup engine 200. The cleanup air filter 210 and the cleanup air actuator 220 may be connected via a manifold, pipe, tube or other suitable structure.

In other embodiments, the cleanup air actuator 220 is in communication with the cleanup engine 200 through an inlet that is different from that used by the producer gas.

The cleanup engine 200 receives the producer gas from the syngas generator 100 and removes the tar. In certain embodiments, the air is heated before entering the cleanup engine 200. For example, as shown in FIG. 8, the air intake line can be arranged such that it passes around the generator flare 140 so that the air intake line can be heated up by the flame and/or the hot exhaust gas of generator flare 140 via conduction. A heat exchanger 142 may also be used to heat the intake air using the gasses from the generator flare 140. A valve 143 may be used to block the flow of producer gas from the syngas generator 100 to the cleanup engine 200, if desired.

The cleanup engine 200 is an internal combustion engine, having one or more cylinders. Each cylinder may have one or more intake valves and one or more outlet valves. The cleanup engine 200 is designed to destroy tar in the producer gas while minimizing the energy consumption so that energy content of clean syngas is high enough to be used in the power producing engine 300. The cleanup engine 200 should therefore operate as rich as possible to maximize left over lower heating value to ensure stable combustion in the power producing engine 300 while ensuring that there was enough heat release in the cleanup engine 200 to destroy tar. Many ignition strategies can be used to achieve rich combustion in the cleanup engine 200, such as ignition sources such as spark-ignition and microwave-ignition, or compression ignition such as homogeneous charge compression ignition (HCCI), partially premixed compression ignition (PPCI), and reactivity controlled compression ignition (RCCI), or a combination of two such as spark assisted HCCI.

The operating speed of cleanup engine 200 may be determined by a tradeoff between the gas throughput and the residence time at high temperature (near top dead center), which determines the destruction of the tars. The engine speed can be adjusted to match the production of the gas from the syngas generator 100 and thus the power produced (or the chemical production rate). Faster speeds result in higher temperatures at top dead center, as there is less time for heat transfer between the gas and the intake manifold/engine cylinder wall. In one embodiment, the engine speed of the cleanup engine 200 may be in a range between 600 revolutions per minute (RPM) and 1500 RPM. Also, it is possible that the engine speed is variable.

The compression ratio of cleanup engine 200 may be chosen to provide enough heat to result in sufficient temperatures at the chosen engine speed (that determines the residence time). High compression ratios may be preferred, while minimizing the changes required in the cleanup engine 200. Furthermore, the stability of the combustion of cleanup engine 200 increases with higher compression ratio. Increasing the compression ratio results in earlier autoignition of the air/fuel mixture in the cylinder (when operating with HCCI mode or spark-assist HCCI). Earlier ignition results in higher temperatures at top dead center. Additionally, increased combustion stability allows a richer air/fuel mixture to be achieved and thus a higher energy content of the clean syngas. In one embodiment, the compression ratio can be in a range between 11:1 and 22:1. Changing the engine compression ratio can be achieved by using a filler introduced from the outside to reduce the volume at top dead center (for example, introduced through the spark plug port or through the glow plug port.

A glow plug may be used in some embodiments, especially when the original cleanup engine is a diesel engine, to help achieve early autoignition when operating in HCCI or spark assisted HCCI operation. In addition, either passive or active prechambers may be used to help increase the stability of the combustion, especially when the combustion is very rich. Prechambers have been proposed for very lean operation, but not for rich operation.

Although operation over a wide range of air-to-fuel ratios is possible, for some applications, the highest quality of the gaseous exhaust from the cleanup engine 200 occurs with very rich operation. The preferred operation may be a relative air-to-fuel ratio of between 0.1 to 0.5 or equivalent ratio (inverse of relative air-to-fuel ratio) of between 2 to 10. The relative air-to-fuel ratio can be adjusted depending on operation (gasifier operating conditions, feedstock, ambient temperature).

In the case of fuel synthesis, in addition to minimizing the loss of heating value of the fuel, it is important to reduce the methane concentration and increase the hydrogen to carbon monoxide ratio, as both methanol and Fischer Tropsch processes require a hydrogen to carbon monoxide ratio of about 2. Partial oxidation in the cleanup engine 200 preferentially eliminates hydrogen, but it can also be used to decrease the level of methane generated by the gasifier. The operating conditions of the cleanup engine 200 can be adjusted (inlet temperature, air-to-fuel ratio, engine speed) to both achieve a high degree of syngas cleanup while also conditioning the gas for further downstream processing. One interesting approach is to use a small electrolyzer to provide some additional hydrogen to the reaction, without having to depend upon gas-water shift. In this embodiment, the co-produced oxygen could be used in the cleanup engine 200. In addition or alternatively, the tail gas from the liquid synthesis reactor could be conditioned and reintroduced into the cleanup engine 200 (for example, through hydrogen recycling).

The producer gas is mixed with air that passes through cleanup air filter 210. In all embodiments, the mixture fed to the cleanup engine 200 is a rich mixture, where the amount of air is less than the stoichiometric amount, up to and including the possibility of running without any free oxygen.

The mixing of the hot producer gas and the air could take place outside or inside the cylinder of the cleanup engine 200. In certain embodiments, the producer gas and the air may be introduced through different intake valves in the cylinder. In another embodiment, the producer gas and the air may be introduced separately just upstream of their respective intake valves so that, for enhanced safety, there is limited mixing outside of the cylinder. The rich mixture is subsequently compressed inside the cylinders of cleanup engine 200. Even without assistance from an ignition source such as a spark plug, the rich mixture will auto-ignite and partially burn at some point during the compression stroke. However, spark discharge may also be used, as in spark-assisted autoignition. Because there is only a limited amount of air available, the rate of pressure rise of auto-ignition in this case is controlled. Because of the rich conditions, only a small amount of the fuel will burn. The pressure and temperature rise, as well as the rise rate, are therefore not destructive for the engine hardware. The in-cylinder temperatures may not be high enough to cause any damage to the engine but they are sufficiently high to destroy the tars. Thus, in certain embodiments, the cylinders of the cleanup engine 200 do not employ an ignition source. Rather, they rely on the rich mixture and high pressure and temperature from engine compression to cause ignition. In other embodiments, a spark plug can be used.

In certain embodiments, it may also be beneficial to control the air/fuel mixture. The additional air for the cleanup engine 200 could be preheated upstream from the manifold, using heat from the exhaust of the power producing engine 300, such as through a heat exchanger 380. The air and producer gas can be premixed upstream from the manifold, or mixed in the manifold or in the cylinder. It is best, in the case where the air is colder than the producer gas, to prevent mixing upstream from the cylinder. It may be desirable to establish stratification on the manifold, to locate clean air in the regions of the valve stem, while keeping the producer gas hotter than if premixed, to minimize tar deposits on the valve stem. Tar deposits on the valve can be minimized by having the producer gas at a higher temperature during the cylinder induction than if premixed with the colder air.

After the tars have been destroyed by the high temperatures caused by compression and partial combustion in the cleanup engine 200, gas is exhausted by the cleanup engine 200. This outputted gas may be referred to as clean syngas, since it lacks the heavy organic components or tars that were present in the intake to the cleanup engine 200.

In addition to creating clean syngas, the combustion within the cylinders of the cleanup engine 200 may rotate a drive shaft 290.

In the embodiment shown in FIG. 1A, the drive shaft 290 is shared with the power producing engine 300. In another embodiment, shown in FIG. 1B, the drive shaft 290 is not shared and may be in communication with a load 280. This load 260 may be a mechanical power plant or an electrical generator, for example. Additionally, a power speed sensor 370, such as a tachometer, may also be disposed at the drive shaft of the power producing engine 300. This power speed sensor 370 may be used to measure the RPM of the power producing engine 300.

The outlet from the cleanup engine 200 may be a manifold, pipe, tube or other suitable structure. The outlet from the cleanup engine 200 is in communication with a cleanup flare actuator 250. The cleanup flare actuator 250 may be a valve that enables or blocks the flow of clean syngas to the cleanup flare 230. The cleanup flare 230 is used to burn any clean syngas that flows into the cleanup flare 230. In certain embodiments, the cleanup flare 230 may comprise an automated spark plug, sensors for emissions and means for emission control. In other embodiments, the cleanup flare 230 may be a length of pipe with an expansion to hold the flame that is manually lit. The cleanup flare 230 is used to ensure that syngas, which contains poisonous carbon monoxide, is not vented into the atmosphere. The cleanup flare 230 and the cleanup flare actuator 250 may be connected via a manifold, pipe, tube or other suitable structure. As with the generator flare 140, the cleanup flare 230 heat can be used for process heating. Further, the heat from the cleanup flare 230 may also be used to heat the coolant or oil that circulates through the cleanup engine 200 and/or the power producing engine 300. This may be achieved using a heat exchanger.

Cleanup flare actuator 250 may be a three-way valve so the exhaust of cleanup engine 200 can also be connected to the intake of cleanup engine 200. Alternatively, another actuator, referred to as the recirculation actuator 251, can be added and used to route the exhaust of the cleanup engine 200 back to its intake. In either case, the controller is in communication with this actuator to control the recirculation of exhaust from the cleanup engine 200 back to the intake. For certain applications (i.e. for the load control of power producing engine 300), a portion of clean syngas at the exhaust of cleanup engine 200 can be recirculated back to the intake of cleanup engine 200. In this manner, the producer gas and the air mixture entering cleanup engine 200 is partially displaced by the recirculated clean syngas, thereby the flow of producer gas from syngas generator 100 is reduced (as are the solid fuel and air feed to the syngas generator 100).

Alternatively, a fraction of the exhaust of the power producing engine 300 could be recycled into either the syngas generator 100 or the intake manifold of the cleanup engine 200.

A cleanup exhaust temperature sensor 260 may be disposed at the outlet of the cleanup engine 200 to measure the temperature of the exhausted syngas. In certain embodiments, the temperature sensor may be a thermocouple or other temperature measuring devices.

Additionally, a cleanup engine sensor 240 may be disposed proximate the cleanup engine 200. In certain embodiments, the cleanup engine sensor 240 may be an accelerometer (knock sensor) either mounted outside or inside of engine cylinder or another acoustic device. In other embodiments, the cleanup engine sensor 240 may be an acoustic sensor. In certain embodiments, the cleanup engine sensor 240 may include both an accelerometer and an acoustic sensor.

Additionally, a cleanup speed sensor 270, such as a tachometer, may also be disposed at the drive shaft 290. This cleanup speed sensor 270 may be used to measure the RPM of the drive shaft 290. In the embodiment shown in FIG. 1A, the cleanup engine 200 and the power producing engine 300 are coupled, either through coupling or via a shared drive shaft 290. Thus, the cleanup speed sensor 270 may also allow the controller 400 to measure the RPM of the power producing engine 300.

The outlet of the cleanup engine 200 is also in communication with a power engine fuel actuator 310. The power engine fuel actuator 310 may be a valve that regulates the flow of clean syngas to the power producing engine 300.

The power producing engine 300 receives air via power engine air actuator 330, which may be a valve. The air may pass through a power engine air filter 320, which may be located upstream from the power engine air actuator 330 and in communication with the power engine air actuator via a manifold, pipe or tube. The filtered air is mixed with the clean syngas and enters the inlet of the power producing engine 300. This may occur within a cylinder of the power producing engine 300 or may occur upstream from the cylinders. The power producing engine 300 may be a spark ignited engine or a compression ignited engine in homogeneous charge compression ignition (HCCI) mode. In other embodiments, the power producing engine 300 may be a dual fuel engine where a small amount of diesel fuel is compression ignited, which then serves to ignite the syngas, much like a spark plug that burns the syngas with a flame front.

The power producing engine 300 generates power, which may be in the form of mechanical rotation of the drive shaft 290. As described above, in certain embodiments, the drive shaft 290 is shared between the cleanup engine 200 and the power producing engine 300. In this embodiment, a load 360 may be in communication with the drive shaft 290. The load 360 may be a mechanical power plant used to create electricity. In other embodiments, the drive shaft 290 is not shared, and the drive shaft from the power producing engine 300 is in communication with load 360.

The exhaust from the power producing engine 300 may be used in a variety of ways. In certain embodiments, it is simply expelled into the atmosphere. In other embodiments, the hot exhaust is recirculated using an exhaust gas recirculation (EGR) unit 373. The exhaust can be directed to the inlet of the syngas generator 100, the intake of the cleanup engine 200, or the intake of the power producing engine 300. In other embodiments, the hot exhaust may enter a catalyst 375 to convert the exhaust gas to a different substance. In other embodiments, the hot exhaust may be supplied to a heat exchanger 380. This heat may be recovered by a heat exchanger 380. The heat extracted by the heat exchanger 380 may be used in a variety of ways. For example, the heat may be used to dry the biomass/air feed to syngas generator 100, which will reduce the tar content in the producer gas. The heat may also be used to pre-heat the manifold between syngas generator 100 and the cleanup engine 200 to avoid tar condensation. Further, the heat may be a system output and used to heat water, for instance.

The controller 400 may include a processing unit, such as a microcontroller, a personal computer, a special purpose controller, or another suitable processing unit. The controller 400 may also include a non-transitory storage element, such as a semiconductor memory, a magnetic memory, or another suitable memory. This non-transitory storage element may contain instructions and other data that allows the controller 400 to perform the functions described herein.

The controller 400 is in communication with cleanup engine sensor 240, cleanup exhaust temperature sensor 260 and cleanup speed sensor 270 so as to monitor the operation of the cleanup engine 200. The controller 400 is also in communication with the cleanup air actuator 220 so as to control the flow of air into the cleanup engine 200. The controller 400 is also in communication with the cleanup flare actuator 250 (if it is a three-way valve) or recirculation actuator 251 so as to control the flow of recirculated clean syngas into the cleanup engine 200.

Having described aspects of the system, the design of the cleanup engine 200 will be described in more detail.

As described above, this is critical to ensure that the tars into the syngas generator 100 remain in the gaseous phase and do not condense causing fouling, either on the pipes upstream of the cleanup engine 200 or in the cleanup engine 200 (for example, in the inlet manifold or on the valves).

Furthermore, in conventional systems, an engine is designed for power. However, in the present system, the cleanup engine 200 is used to destroy tar. Because of the different design goals, modifications may be made to the cleanup engine 200 to optimize its performance for its intended function. These modifications include the following.

First, the distance between the outlet of the syngas generator 100 and the inlet of the cleanup engine 200 may be minimized. By reducing the distance, the producer gas remains at a high temperature. This is important for fuel-rich combustion and also preventing the condensation of tar prior to entering the cleanup engine 200. This distance may be 36 inches or less, in certain embodiments.

Next, the manifold connecting the outlet and the inlet may be thermally insulated. This may be done for the same reasons as listed above.

Third, the inner surface area of cleanup engine intake system may be reduced or minimized. This will reduce the thermal boundary layer and thus limit the tar condensation. Specifically, the number of intake valves should be reduced to a minimum. Currently, most modern engines have two intake valves with two intake runners and ports per cylinder. That is, the intake gas will split into two streams at intake of the engine and each stream has its own path. This will greatly increase the contact area of producer gas and will promote tar fouling and plugging issues. To optimize tar cleanup, the number of intake valves (and thus intake port and runners) may be reduced to one. In certain embodiments, exactly one intake valve is used for each cylinder.

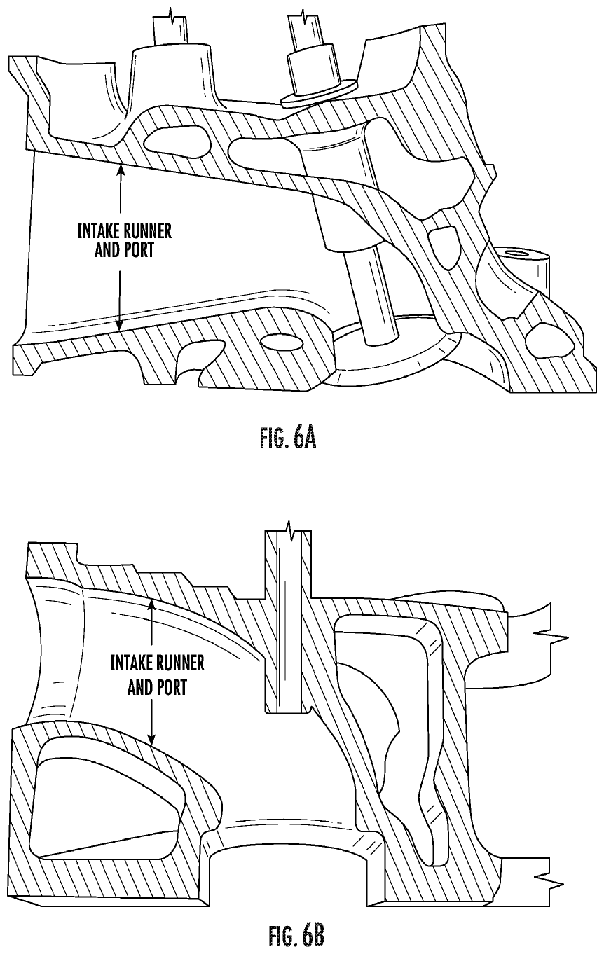

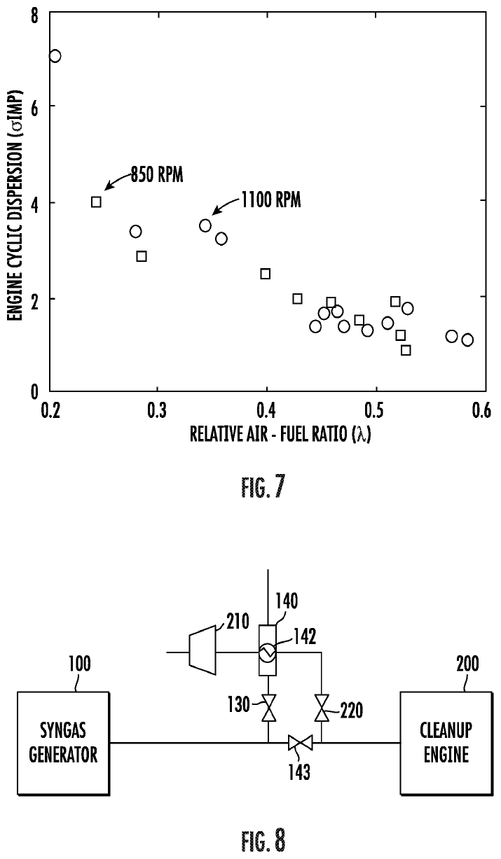

Fourth, the intake runner and port may be redesigned. The modern engine intake runner and port are inflected and the cross-sectional area is converged to achieve swirls during intake process so that the air and fuel can mix better. However, in the present system, the air and producer gas are premixed. Therefore, such swirls are unnecessary and the inflected and converged design of intake runner and port may promote tar fouling and plugging issue. To optimize tar cleanup, the inflected and converged design of intake runner and port should be modified to a straight design with uniform inner diameter. FIG. 6A shows a conventional intake runner and port with decreasing inner diameter and inflections. FIG. 6B shows the new intake runner and port with a uniform inner diameter and straight design.

Fifth, the engine cylinder head may be redesigned. The cleanup engine cylinder head should be a pent roof rather than having a flat shape. The pent roof shape provides some angle. In the case when the soot is formed in the cleanup engine 200, an angled shape can effectively prevent the soot deposit on the cylinder head. These deposits may lead to the impact between cylinder head and piston.

Sixth, the engine coolant temperature (ECT) should be as high as possible (but within the engine constraints). This will increase the temperature of the producer gas contacting surfaces. The producer gas is therefore less likely to condense. This can be achieved by using a different engine coolant fluid.

Seventh, the engine compression ratio can be adjusted. The purpose of the cleanup engine is to reach high enough temperatures to eliminate the tars, rather than to optimize efficiency. Thus, it may be desirable to increase the compression ratio of the engine.

Lastly, different valve springs may be used. Stiff valve springs should be used so that the cleanup engine can still function even in the case where tar is condensed, solidified and formed a bond between valves and cylinder head during the start up. These valve springs may have a spring constant that is 20-80% higher than conventional valve springs, which may be about 300 lbs./in. The stiff valve springs also help to prevent leaks in the situation where tar is condensed and accumulated on the valve seals during operation. During engine operation, the condensed tar is viscous and stiff valve springs will provide more force to the valve closing so the viscous tar can be squeezed out of valve seals. The disadvantage with strong valve springs is the engine friction will be higher, however, such friction increment is small comparing to the power produced by the system.

In addition to proper design, proper control and operation of the cleanup engine 200 is critical to the performance of the integrated system.

For the cleanup engine 200, designed for combustion with hot rich mixture, less rich conditions (i.e. more air/oxidant) may lead to a higher in-cylinder pressure rise rate that can induce engine knock and damage the engine, whereas richer condition (i.e. less air/oxidant) may lead to unstable combustion that can induce misfire to stall the engine. The two extreme conditions are defined as upper and lower limits, respectively, of the air to fuel ratio (λ).

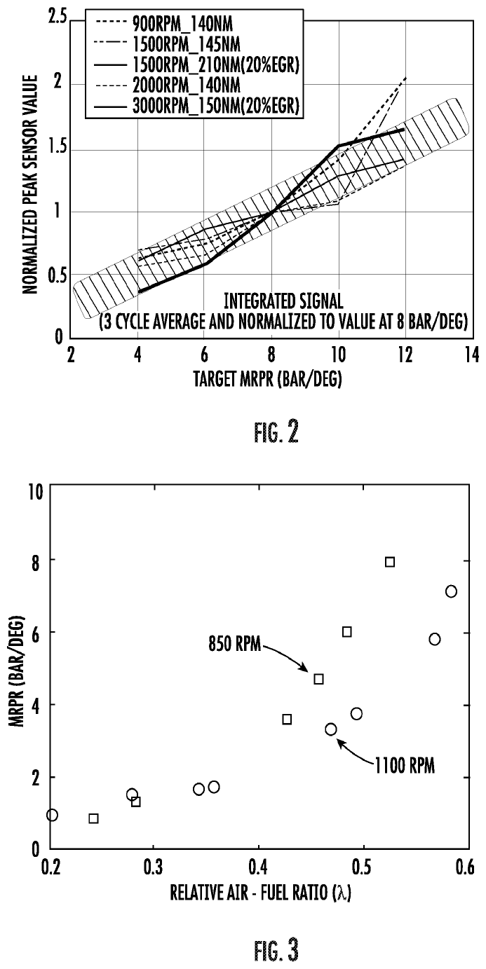

For the upper limit, it is known that the engine performance is limited by the maximum rate of pressure rise (MRPR). MRPR increases with increasing engine load and eventually causes engine knock. FIG. 2 shows the signal of a conventional, out-of-cylinder acoustic knock sensor as a function of MRPR in an engine. This acoustic knock sensor may be the cleanup engine sensor 240. As is shown, the sensor signal increases with increasing MRPR. This is consistently true across various RPM.

FIG. 3 shows the MRPR as a function of λ (air-to-fuel ratio) in a prototype cleanup engine fueled with producer gas with high tar content. Two operating parameters are shown; 850 RPM and 1100 RPM. At both rotational speeds, MRPR increases with increasing A. Combining the relationships shown in FIG. 2 and FIG. 3, it can be seen that the signal of a knock sensor increases with increasing λ, and vice versa.

Therefore, a maximum allowable output of the cleanup engine sensor 240 may be established as a maximum threshold and stored in the storage element of the controller 400. The controller 400 may adjust the cleanup air actuator 220 to reduce the flow of air therethrough if the output of the cleanup engine sensor 240 approaches or exceeds this threshold. In this mode, the cleanup engine sensor 240 is used to monitor the upper limit of λ.

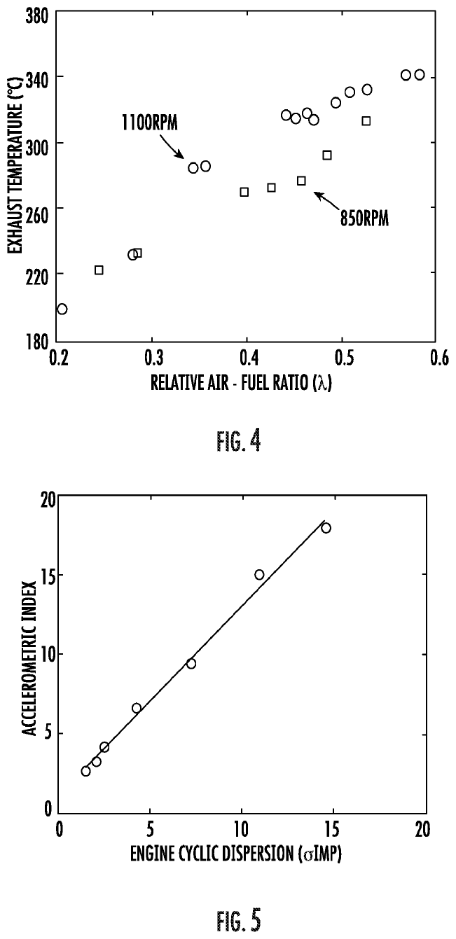

Furthermore, FIG. 4 shows the exhaust temperature as a function of λ in a cleanup engine 200 fueled with producer gas with high tar content. Again, this relationship is plotted for two different rotational speeds; 850 RPM and 1100 RPM. As is shown, exhaust temperature increases with increasing λ at both rotational speeds, and vice versa. By disposing a cleanup exhaust temperature sensor 260 at the outlet of the cleanup engine 200, it is possible to determine the exhaust temperature. By using the relationships between output of the cleanup exhaust temperature sensor 260, RPM and λ, it is possible to determine the value of λ. The correlation may be incorporated in a lookup table that includes exhaust temperature, RPM and λ. Thus, in certain embodiments, a maximum allowable exhaust temperature may be set as a threshold and stored in the storage element of the controller 400. The value monitored by the cleanup exhaust temperature sensor 260 may be compared to this threshold. As the exhaust temperature nears or exceeds this threshold, the controller 400 may activate the cleanup air actuator 220 to reduce the flow of air therethrough, thereby lowering λ.

Thus, by using the cleanup engine sensor 240, the cleanup exhaust temperature sensor 260 or both, the upper limit of air to fuel ratio in the cleanup engine 200 can be controlled. For example, if λ is too high, the cleanup air actuator 220 may be actuated so as to reduce the flow of air therethrough. This has the effect of decreasing λ.

For the lower limit, it is known that engine becomes unstable when λ is either too rich or too lean. FIG. 5 shows the processed signal of an out-of-cylinder accelerometer versus engine cyclic dispersion. The cyclic dispersion is defined as the standard deviation of engine indicated mean effective pressure (σᵢₘₚ). σᵢₘₚ is calculated from in-cylinder pressure and has been widely used in engine combustion stability research. The higher the σᵢₘₚ, the less stable the engine combustion, and vice versa. However, σᵢₘₚ requires a very expensive in-cylinder pressure sensor and therefore is not used for mass production engines. On the other hand, an out-of-cylinder accelerometer/knock sensor, such as cleanup engine sensor 240, is a very inexpensive device. As shown in FIG. 5, the signal of accelerometer increases linearly with increasing engine cyclic dispersion. Furthermore, FIG. 4 shows the exhaust temperature as a function of λ in a cleanup engine fueled with producer gas. As is shown, exhaust temperature decreases with decreasing λ. FIG. 7 shows the relationship between cyclic dispersion and λ. Using this relationship in conjunction with the relationships shown in FIG. 4 and FIG. 5, correlations may be created between exhaust temperature, RPM, λ and accelerometer signal. With these correlations, the upper and lower limits of λ can be defined by setting up a threshold value for the output of the cleanup engine sensor 240 and exhaust temperature. The data can be stored in a lookup table stored in the controller 400.

As described above, there are two possible embodiments. There is a first embodiment where the cleanup engine 200 shares the same rotational shaft with power producing engine 300, as shown in FIG. 1A; and a second embodiment where the cleanup engine 200 does not share the same rotational shaft with power producing engine 300, as shown in FIG. 1B.

In both embodiments, the load may be a generator that produces electricity to a microgrid or it may be a unit, such as pump, that produces mechanical work for various purposes.

For each configuration, there are different timescales of load change and therefore different required engine control adjustments.

The fastest timescales are those dictated by electrical stability requirements. These requirements may include maintaining AC power frequency and voltage levels in a microgrid environment when large (as a percentage of the total generation in the microgrid) loads are connected or disconnected. In this scenario, the required response time for the generator ranges from a few electrical cycles (which may be ˜20 ms each) to a few seconds.

The slowest timescales of load change are usually slower than 30 minutes to an hour and usually refers to more predictable behavior of many smaller loads such as diurnal changes in a large grid due to many consumers using less electricity late in the night.

In the embodiment of FIG. 1A, when two engines are sharing a common drive shaft 290, there is only one load 360 coupled to the power producing engine 300. If the load 360 is an electric generator, there are two options for the use of the engine to produce electricity, depending on whether the electricity is DC or AC.

Although there are disadvantages because the need for a rectifier in the case of DC, DC may be easier to use in limited microgrids. One of the advantages of DC is that the generator can operate at relatively high frequencies, making the generator smaller and the engine control simpler, since the engine speed can be modulated. One advantage of higher frequency generator is that the rectification is easier. However, the rectification component adds a substantial cost to the system. Although more expensive, it has longer lifetimes than the power engine and lower maintenance. The engine can operate at relatively high/variable engine speed, producing more power for a given peak pressure in the engine or as limited by engine knock.

If the power grid is AC, the engine speed should be tightly controlled as it is proportional to electric power frequency. It is usually operating at 1800 rpm in order to generate 60 Hz with a 4-pole generator.

In either case of a DC or AC microgrid, any changes in the load will change engine speed. In the case of an AC microgrid, the system should respond to the change and maintain the engine speed. Because of the constant engine speed, power can only be adjusted by modifying the engine torque (measured as mean brake torque). A cleanup speed sensor 270 or a power speed sensor 370 can be used to monitor the engine speed. Changes in engine speed can be detected and compensated for by throttling or unthrottling the power engine fuel actuator 310 and/or the power engine air actuator 330.

For fast load control, as the load 360 is only connected to the power producing engine 300 and not to the cleanup engine 200, to optimize tar cleanup, the λ of the cleanup engine 200 should remain the same. The load control for the power producing engine 300 is achieved by adjusting power engine fuel actuator 310 or/and the power engine air actuator 330. If the load control is achieved via only one of the power engine fuel actuator 310 or the power engine air actuator 330, the power producing engine 300 will operate either richer (λ<1) or leaner (λ>1) from stoichiometry. This will change the torque produced by power producing engine 300. In the case of richer operation, the catalyst 375 will take care of the harmful exhaust. If the load control is achieved via both the power engine fuel actuator 310 and the power engine air actuator 330, the power producing engine 300 will operate at stoichiometry (λ=1). As the two engines are sharing a common shaft, the power producing engine 300 is therefore throttled. This will change the torque produced by power producing engine 300. In either case, because the two engines are sharing a common shaft, recirculation actuator 251 (or cleanup flare actuator 250 if it is a 3-way valve) may need to be adjusted so any syngas that accumulated in the line between cleanup engine 200 and power engine fuel actuator 310 can be recirculated back to the intake of cleanup engine 200. The cleanup air actuator 220 may be adjusted to the optimal λ for tar cleanup, which may be determined from a lookup table.

For slow load control, the flow of solid fuel and air into the syngas generator 100 and thus the producer gas flow rate are changed. To optimize tar cleanup, cleanup air actuator 220 should be adjusted to the optimal λ for tar cleanup (which can be determined from a lookup table). For example, when the load demand is reduced, the flow through syngas air actuator 120 and the syngas fuel actuator 110 are decreased so that less producer gas is produced and flowed into the cleanup engine 200. Cleanup air actuator 220 also may be turned down to maintain the appropriate λ. As the cleanup engine speed cannot be varied (due to shared shaft), this will throttle the cleanup engine 200. Alternatively, exhaust gas from power producing engine 300 can be recirculated to the syngas generator 100 via exhaust gas recirculation (EGR) unit 373 or to the intake manifold of the cleanup engine 200. In this case, the syngas air actuator 120 may remain unchanged and only syngas fuel flow varies via syngas fuel actuator 110. This will not throttle the cleanup engine 200 by simply replacing part of producer gas with inert exhaust gas. Again, cleanup air actuator 220 also may be varied to maintain the appropriate λ.

In the second embodiment, shown in FIG. 1B, where the two engines are not sharing a common shaft, there is a load 280 coupled to the cleanup engine 200. If the load 280 is an electric generator (separate from the electric generator that is connected to the power producing engine), there are two options for the use of the engine to produce electricity, depending on whether the electricity is DC or AC. The design considerations associated with each option are described above and are not repeated here.

In either case of a DC or AC microgrid, any changes in the load will change engine speed. In the case of an AC microgrid, the system should response to the change and maintain the engine speed. Because of the constant engine speed, power can only be adjusted by modifying the engine torque (measured as mean brake torque). A cleanup speed sensor 270 can be used to monitor the engine speed.

For fast load control, the load control for the power producing engine 300 is achieved by adjusting power engine fuel actuator 310 or/and power engine air actuator 330. If the load control is achieved via only one of the power engine fuel actuator 310 or the power engine air actuator 330, the power producing engine 300 will operate either richer (λ<1) or leaner (λ>1) from stoichiometry. This will change the torque produced by power producing engine 300. In the case of richer operation, the catalyst 375 will take care of the harmful exhaust. If the load control is achieved via power engine fuel actuator 310 and the power engine air actuator 330, the power producing engine 300 will operate at stoichiometry (λ=1). This will change the torque produced by power producing engine 300. In either case, because the two engines can have different speeds, the speed of the cleanup engine 200 can be adjusted according to the torque change of power producing engine 300 so the throttling can be avoided (i.e. if less torque is needed in the power producing engine 300, the power engine fuel actuator 310 is reduced so less syngas flows through and the cleanup engine speed can be reduced accordingly). Because the speed of the cleanup engine 200 can be varied, the cleanup flare actuator 250, and/or the recirculation actuator 251 may not need to be adjusted as there are no available syngas accumulation in the line between cleanup engine 200 and power engine fuel actuator 310, which is needed to be recirculated back to the intake of cleanup engine 200. However, as the speed of the cleanup engine 200 changes, the cleanup air actuator 220 may still need to be adjusted to the optimal λ for tar cleanup, which may be determined from a lookup table.

For slow load control, the flow of solid fuel and air into the syngas generator 100 and thus the producer gas flow rate are changed. To optimize tar cleanup, cleanup air actuator 220 should be adjusted to the optimal λ for tar cleanup (which can be determined from a lookup table). For example, when the load demand is reduced, the flow through syngas air actuator 120 and the syngas fuel actuator 110 are decreased so that less producer gas is produced and flowed into the cleanup engine 200. Cleanup air actuator 220 also may be turned down to maintain the appropriate λ. As the speed of the cleanup engine 200 is variable, this will not throttle the cleanup engine 200. Alternatively, exhaust gas from power producing engine 300 can be recirculated to the syngas generator 100 via exhaust gas recirculation (EGR) unit 373. In this case, the syngas air actuator 120 remain unchanged and only the flow of syngas fuel varies via syngas fuel actuator 110. Again, cleanup air actuator 220 also may be varied to maintain the appropriate λ.

In certain embodiment, a diesel particulate filter (DPF) can be inserted in the manifold between cleanup engine 200 and power producing engine 300. The DPF will purify the syngas by removing soot particles from it (these soot particles, which can be produced during tar destruction process in the cleanup engine, under high pressure condition). After certain hours of operation, the DPF needs to be regenerated to oxidize the trapped soot to avoid blockage. Regeneration can be done during the system startup and shutdown process. For example, in the startup process, cleanup engine 200 needs to be warmed up, and during this process, the exhaust syngas of cleanup engine 200 will be burned through cleanup flare 230. The hot exhaust gas of cleanup flare 230 can be circulated into the DPF and thus used for regeneration.

While FIGS. 1A-1B show an integrated system having a generator flare 140, a cleanup flare 230 and various actuators, in certain embodiments, the control of the cleanup engine 200 may be performed in a system that does not include these components.

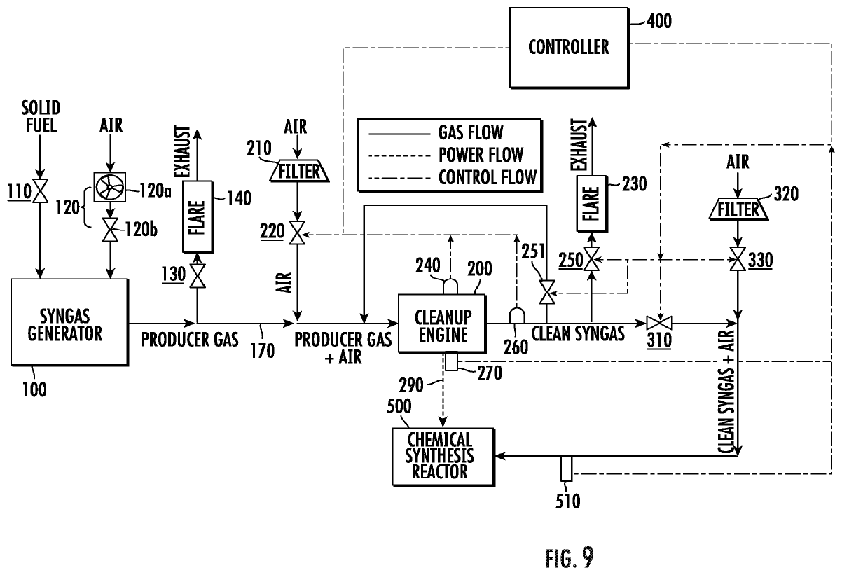

For example, as shown in FIG. 9, the system may include a chemical synthesis reactor 500. This chemical synthesis reactor 500 may replace the power producing engine 300, or be in addition to it. In this embodiment, downstream from the cleanup engine 200, there could be a system that conditions the clean syngas and introduces it into a chemical synthesis reactor 500. The chemical synthesis reactor could be for synthesizing methanol, ammonia, FT diesel or other chemicals. As most synthesis processes require high pressure (higher than power generation), the exhaust of cleanup engine 200 needs to be pressurized. Thus, in certain embodiments, a pressure sensor 510 may be used to monitor the pressure at the intake to the chemical synthesis reactor 500. The controller 400 may use the output from this pressure sensor 510 to control the power engine fuel actuator 310. The cleanup engine 200 can pressurize the exhaust, by throttling of the exhaust of the cleanup engine 200. Some chemical synthesis reactors require pressures higher than 20 bar. Some of the power from the cleanup engine 200 will go towards compressing the clean syngas, reducing the fuel available for driving the power producing engine, in the case that there are both a chemical synthesis reactor and a power producing engine. It is possible to have pressure ratios of 3-5 (ratio of the intake to exhaust pressures) in the cleanup engine. For this chemical synthesis application, it would be beneficial if the syngas generator 100 is operating at higher pressures, as the exhaust pressure would be higher. For example, if the intake manifold pressure is 4 bar and the pressure ratio is 3, the exhaust pressure can be as high as 12 bar. High engine-out pressures are desirable in that they minimize the need for further gas compression upstream from the chemical synthesis reactor 500. The inlet of the syngas generator 100 could be pressurized using a turbo charger or a super charger that runs off the cleanup engine 200 or the power producing engine, if it is available. Alternatively, it could be a conventional compressor using electrical power from the cleanup engine or power producing engine, if available.

In some embodiments, the chemical synthesis reactor 500 is an engine reactor. A catalyst is placed in the cylinder of the engine reactor. The pressurization of the intake for the engine reactor can be achieved in several ways. In a first embodiment, similar to that shown in FIG. 1A, the cleanup engine 200 and the engine reactor are sharing a common shaft. In this embodiment, the cleanup engine 200 can be designed to have greater displacement volume than the engine reactor. For example, if engine reactor has a displacement of 2.0 L, the cleanup engine 200 can have a displacement of 3.0 or 4.0 L. Since the two engines will run at the same speed, a larger cleanup engine exhaust connects to a smaller engine reactor will pressurize the line between them. The larger displacement volume of cleanup engine 200 can be achieved by increasing the number of cylinders or the bore and stroke size or both. Alternatively, if the two engines are having the same displacement volume, a speed differentia system can be inserted on the shared shaft. This will reduce the speed of the engine reactor and make it relatively slow as compared to the cleanup engine speed. Therefore, pressurization of the engine reactor intake can be achieved.

In a second embodiment, similar to that shown in FIG. 1B, where the two engines are not sharing a common shaft, the engine speed between cleanup engine 200 and engine reactor can be varied. The pressurization of the engine reactor can be achieved simply by running the cleanup engine 200 relatively faster than the engine reactor. However, an external electric motor may need to be mounted on the engine reactor to provide additional power to maintain the engine speed (since it is used for chemical synthesis).

In certain embodiment, the function of the cleanup engine 200 may not be limited to tar cleanup, but also targeted for power production. That is, the cleanup engine 200 may run at less rich condition, but still rich enough that it does not knock (i.e. within the upper limit previously defined). This will increase the cleanup engine power output. The higher power output from the cleanup engine 200 can be useful in certain applications. Note that the less rich condition of cleanup engine 200 is not only producing higher power but also make the syngas cleaner (i.e. less tar), which means the syngas will have higher purity. This can be important as the tar tolerance level for chemical synthesis can be different from that for power generation. On the other hand, the lower heating value (LHV) of the clean syngas will be decreased.

Although the syngas generator described thus far described runs on biomass, it may be possible to have additional fuel introduced into the gasifier, including coal, wastes (for example, but not limited to agricultural or forest wastes, foods, paper), biogas, or other fuels, or mixture thereof, in addition to the standard biomass. The process is effective for any gasification process that results in the production of tars.

In summary, there are three possible utilizations of the clean syngas from the cleanup engine 200: it can be used for power, for chemical synthesis or for heating. Power and chemical production have been described above. Heating can be the result of combustion of the syngas for liquid, gas or solid heating, including water or air heating, or drying applications. These applications can accommodate large changes in rate. The heating application can make use of the flare system. The cleanup engine can be a part of a system with polygeneration, where the outputs (power, chemicals or heat) can be adjusted for control and/or optimal performance of the system. Thus, power variations can be readily accommodated by changes in the heating or the chemical production.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An integrated system for producing power from solid fuels, comprising:
a syngas generator to form producer gas from solid fuels;
a cleanup engine in communication with an outlet of the syngas generator to remove tar from the producer gas and create cleaned syngas;
a power producing engine in communication with an outlet of the cleanup engine to generate power;
a power engine fuel actuator disposed between the outlet from the cleanup engine and an inlet of the power producing engine;
a cleanup air filter;
a cleanup air actuator in communication with the cleanup air filter and an inlet of the cleanup engine;
a cleanup engine sensor;
a cleanup exhaust temperature sensor; and
a controller in communication with the cleanup engine sensor, the cleanup exhaust temperature sensor and the cleanup air actuator.

2. The integrated system of claim 1, wherein a distance between the outlet of the syngas generator and an input to the cleanup engine is less than 36 inches.

3. The integrated system of claim 1, wherein a manifold between the outlet of the syngas generator and an input to the cleanup engine is thermally insulated.

4. The integrated system of claim 1, wherein each cylinder of the cleanup engine has exactly one intake valve.

5. The integrated system of claim 1, wherein an intake runner and port are used to deliver producer gas to a cylinder of the cleanup engine and the intake runner and port have straight designs with uniform inner diameters.

6. The integrated system of claim 1, wherein an engine cylinder head of the cleanup engine comprises a pent roof.

7. The integrated system of claim 1, wherein a valve spring used to control an intake valve has a spring constant that is 20-80% greater than conventional valve springs.

8. The integrated system of claim 1, wherein air is heated prior to entering the inlet of the cleanup engine.

9. An integrated system for producing power from solid fuels, comprising:
a syngas generator to form producer gas from solid fuels;
a cleanup engine in communication with an outlet of the syngas generator to remove tar from the producer gas and create cleaned syngas;
a power producing engine in communication with an outlet of the cleanup engine to generate power;
a power engine fuel actuator disposed between the outlet from the cleanup engine and an inlet of the power producing engine;
a cleanup air filter;
a cleanup air actuator in communication with the cleanup air filter and an inlet of the cleanup engine;
a cleanup engine sensor;
a cleanup exhaust temperature sensor;
an electrical generator coupled to a drive shaft of the power producing engine; and
a controller in communication with the cleanup engine sensor, the cleanup exhaust temperature sensor and the cleanup air actuator.

10. The integrated system of claim 9, wherein the controller monitors the cleanup exhaust temperature sensor and adjusts the cleanup air actuator in response to values received from the cleanup exhaust temperature sensor.

11. The integrated system of claim 10, wherein the controller maintains an air-to-fuel ratio (λ) of the cleanup engine within a predetermined range.

12. The integrated system of claim 11, wherein the cleanup engine sensor comprises a knock sensor, and an upper and lower limit of λ is determined based on an output of the cleanup engine sensor and/or exhaust temperature from the cleanup exhaust temperature sensor.

13. The integrated system of claim 12, wherein the knock sensor is an accelerometer, an acoustic device or both.

14. The integrated system of claim 9, further comprising a syngas fuel actuator; and
a syngas air actuator;
wherein a load presented by the electrical generator varies over time and the controller varies a flow rate of solid fuel and/or air entering the syngas generator in response to variation in the load.

15. The integrated system of claim 9, wherein an output gas from the power producing engine is recirculated back to an input to the cleanup engine and wherein a load presented by the electrical generator varies over time and the controller controls the cleanup air actuator to maintain an air-to-fuel ratio (λ) within a predetermined range.

16. The integrated system of claim 9, wherein an operating speed of the cleanup engine is between 600 and 1500 RPM.

17. The integrated system of claim 9, wherein a compression ratio of the cleanup engine is between 11:1 and 22:1.

18. The integrated system of claim 9, wherein a relative air-to-fuel ratio of the cleanup engine is between 0.1 and 0.5.

19. An integrated system for synthesizing chemicals from solid fuels, comprising:
a syngas generator to form producer gas from solid fuels;
a cleanup engine in communication with an outlet of the syngas generator to remove tar from the producer gas and create cleaned syngas; and
an engine reactor in communication with an outlet of the cleanup engine to synthesize the cleaned syngas into a desired chemical.

20. The integrated system of claim 19, wherein exhaust from the cleanup engine is pressurized before entering the engine reactor.

21. The integrated system of claim 19, wherein the cleanup engine and the engine reactor share a common drive shaft and a displacement of the cleanup engine is greater than the displacement of the engine reactor.

22. The integrated system of claim 19, wherein the cleanup engine is operated at a higher RPM than the engine reactor.
